(19) United States
(12) Patent Application Publication
(10) Pub. No.: US 2024/0112563 A1
(43) Pub. Date: Apr. 4, 2024

(54) BLUETOOTH ENABLED SMART RING

(71) Applicant: Opal Wearables, Inc., Brooklyn, NY (US)

(72) Inventors: Lance Norman, Jersey City, NJ (US); Han Hua Jennifer Chiang, New York, NY (US); Stephane Krumenacker, Denver, CO (US)

(73) Assignee: Opal Wearables, Inc., Brooklyn, NY (US)

(21) Appl. No.: 18/365,737

(22) Filed: Aug. 4, 2023

Related U.S. Application Data
(60) Provisional application No. 63/474,944, filed on Sep. 29, 2022.

(51) Int. Cl. G08B 25/01; G06F 1/16; G06F 3/01; G08B 25/00

(52) U.S. Cl. CPC G08B 25/016; G06F 1/163; G06F 3/016; G08B 25/006

(57) ABSTRACT

A system may include a smart ring device capable of wireless communication with a computing device that is configured to transition between one or more states based on user and/or device inputs. In response to switching from a first state to a second state, the smart ring device may send an electronic signal to the computing device indicating the switching. The first state may correspond to a normal condition, and the second state to an emergency condition. In response to receiving the switching related electronic signals from the smart ring device, the computing device may send a request to a second computing device associated with a third-party emergency response service for dispatching resources to a location. Upon receiving confirmation that the signal has been communicated, the smart ring device may provide an output (e.g., vibrate) to confirm success of the sent signal.

### CROSS-REFERENCE TO RELATED APPLICATIONS

The present application claims priority to and benefit of U.S. Provisional Patent Application No. 63/474,944, filed Sep. 29, 2022, and entitled “Bluetooth enabled smart ring containing input sensor, capable of contacting authorities in case of an emergency,” the entirety of which is herein incorporated by reference.

### FIELD

The present disclosure relates to the field of wearable devices. More particularly, to smart ring devices capable of wirelessly communicating requests based on user inputs.

### BACKGROUND

Electronic devices that are wearable by a user typically include sensors for monitoring parameters associated with the user. These wearable devices can display the parameters on a display of the device or can send the parameters to an external computing device to be further analyzed and/or to display the parameters. Furthermore, based on the parameters exceeding predefined limits, the device or the external computing device can alert the user.

### SUMMARY

In some embodiments, a safety system includes a smart ring device, the smart ring device being capable of wireless communication, and the smart ring device being configured to transition between one or more states based on inputs from a user. The safety system includes a first computing device including a computer-readable medium having stored thereon instructions for sending a request to a second computing device associated with a third-party emergency response service for dispatching resources to a location of the first computing device. In response to switching from a first state to a second state, the smart ring device sends an electrical signal to the first computing device indicative of an emergency condition associated with the user and for the first computing device to send the request to the second computing device.

In some embodiments, the smart ring device is configured to provide haptic feedback through vibrations in response to the inputs from the user and in response to the smart ring device transitioning to each of the one or more states.

In some embodiments, the smart ring device includes a ring-shaped body including a receptacle disposed along a portion of an outer surface of the ring-shaped body, a top plate movably coupled to the ring-shaped body at the receptacle, and a printed circuit assembly including a vibration component, a battery, a communication module, and a tactile switch. The printed circuit assembly is disposed in the receptacle between the ring-shaped body and the top plate. In response to a force being applied to the top plate and triggering the tactile switch, the printed circuit assembly transitions the smart ring device between one of the one or more states to another one of the one or more states.

In some embodiments, the printed circuit assembly further includes a controller, wherein the controller is configured to control an operation of one or more components of the printed circuit assembly based on a life of the battery.

In some embodiments, the communication module includes a Bluetooth Low Energy (BLE) System-on-Chip (SoC), the communication module being capable of Bluetooth enabled communication with the first computing device.

In some embodiments, after a first defined time period, the smart ring device switches from the first state to a third state and cycles the vibration component to physically signal the user to provide the input to the smart ring device to return the smart ring device to the first state.

In some embodiments, in response to the smart ring device receiving the input from the user for a specific duration of time within a second defined time period, the smart ring device switches from the third state to the first state, and, in response to the smart ring device not receiving the input from the user within the second defined time period, the smart ring device switches to the second state.

In some embodiments, a smart ring apparatus includes a body including a receptacle disposed along a portion of an outer surface of the body, a top plate configured to movably couple to the body, and a printed circuit assembly including a vibration component, a battery, a communication module capable of Bluetooth wireless communication with a first computing device, and a tactile switch, the printed circuit assembly being disposed at the receptacle between the body and the top plate, and where the printed circuit assembly switches between one or more states based on an input from a user applied to the top plate triggering the tactile switch.

In some embodiments, the printed circuit assembly cycles the vibration component to provide haptic feedback to the user in response to the inputs from the user and in response to the printed circuit assembly switching between each of the one or more states.

In some embodiments, in response to triggering the tactile switch, the printed circuit assembly switches from a first state to a second state and sends an electrical signal to the first computing device, the second state being indicative of an emergency condition associated with the user. In some embodiments, in response to the electrical signal indicative of being in the second state, the first computing device sends a request to a second computing device associated with a third-party emergency response service for dispatching resources to a location of the first computing device.

In some embodiments, after a first defined time period, the printed circuit assembly switches to a third state and cycles the vibration component to physically signal to the user to press the top plate and trigger the tactile switch to return the printed circuit assembly to the first state.

In some embodiments, in response to the tactile switch being triggered for a specific duration within a second defined time period, the printed circuit assembly switches from the third state to the first state.

In some embodiments, in response to the tactile switch not being triggered within the second defined time period, the printed circuit assembly switches to the second state.

In some embodiments, the printed circuit assembly includes a controller, the controller being configured to control operations of the printed circuit assembly to extend a life of the battery.

In some embodiments, the communication module includes a BLE SoC.

In some embodiments, a method for initiating emergency alerts using a smart ring device and a first computing device includes activating, by the smart ring device, an emergency alert system in response to an input from a user triggering the smart ring device to switch from a first state to a second state, sending, by the smart ring device and based on the input from the user triggering the second state, an electronic signal to a first computing device corresponding to a request for emergency response services to be dispatched to a location of the first computing device, obtaining, by the first computing device, a confirmation from the second computing device indicative of resources being dispatched to the location of the first computing device, and triggering, by the smart ring device, haptic feedback by cycling a vibration component to physically signal to the user the confirmation.

In some embodiments, the method further includes receiving, at the smart ring device, an input from the user at a top plate of the smart ring device and triggering a trigger switch to cause the smart ring device to switch from the first state to the second state, and sending and receiving BLE packets between the smart ring device and the first computing device, the BLE packets including the request for the emergency response services.

In some embodiments, the method further includes switching, by the smart ring device after a first defined time period, from the first state to a third state and cycling the vibration component to physically signal to the user to provide the input to the smart ring device to return the smart ring device to the first state.

In some embodiments, the method further includes switching, in response to the smart ring device receiving the input from the user for a specific duration of time within a second defined time period, the smart ring device from the third state to the first state.

In some embodiments, the method further includes switching, in response to the smart ring device not receiving the input from the user within the second defined time period, the smart ring device from the third state to the second state, and sending, by the smart ring device in response to switching from the third state to the second state, the electronic signal to the first computing device corresponding to a request for emergency response services to be dispatched to the location of the first computing device.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 illustrates a perspective view of a non-limiting embodiment of a device described herein.

FIG. 2 illustrates a flow diagram of a system including the device of FIG. 1, according to some embodiments.

FIG. 3 illustrates a first partially exploded view of the device, according to some embodiments.

FIG. 4 illustrates a second partially exploded view of the device, according to some embodiments.

FIG. 5 illustrates a top view of a printed circuit assembly, according to some embodiments.

FIG. 6 illustrates a schematic diagram of a top view of the printed circuit assembly, according to some embodiments.

FIG. 7 illustrates a schematic diagram of a bottom view of the printed circuit assembly, according to some embodiments.

FIG. 8 illustrates a block diagram of the printed circuit assembly, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Various embodiments of the present disclosure relate to systems, devices, apparatuses, and methods for switching, based on inputs from a user, a smart ring device between one or more states and for performing one or more operations in response to the smart ring device switching between the one or more states. According to some embodiments, a system may include a smart ring device in a communicable connection with a computing device. The smart ring device and the computing device may be operated in tandem with each other to provide a user with the capability to request dispatch of emergency response services from a third-party provider. Based on inputs from a user, the smart ring device may switch between the one or more states and the smart ring device may send electronic signals to the computing device indicative of the switching from one state to another state.

In various embodiments, the smart ring device may be in communicable connection with the computing device. In some embodiments, the smart ring device may be in wireless communicable connection with the computing device. In other embodiments, the smart ring device may be in communicable connection with the computing device using a wireless communication protocol, such as Bluetooth. According to an embodiment, the smart ring device and the computing device may send electronic signals between each other in the form of BLE signal packets, the electronic signals being indicative of a user input corresponding to the smart ring device switching between states, requests for user input, requests for emergency response services, confirmation of user response services, status of the smart ring device, status of the computing device, other like features, or any combinations thereof.

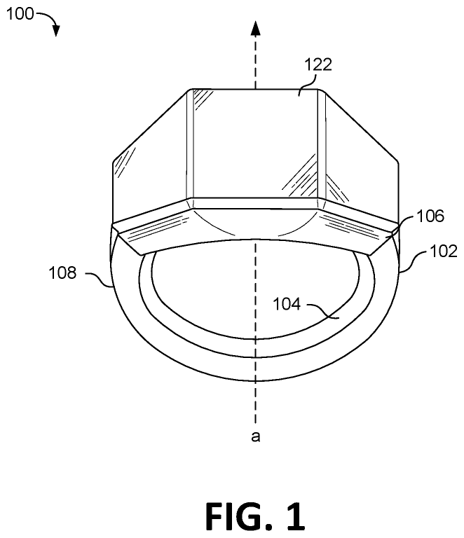

FIG. 1 illustrates a perspective view of a device 100, according to some embodiments. The device 100 may be a smart device capable of being in wirelessly communicable connection with a computing device, as will be further described herein. In some embodiments, the device 100 may be a smart ring device configured to be worn by the user such as, for example, on the user's finger.

The device 100 includes a body 102. In some embodiments, the body 102 may include a bore 104 extending therethrough in an axial direction a, as shown in FIG. 1, which may define the ring-shape of the body 102. The body 102 may include appropriate dimensions so that the device 100 may be worn by a user, while allowing the device 100 to house one or more components which allow the device 100 to receive user inputs which trigger the device 100 to switch between the one or more states and to send and receive electronic signal packets between the device 100 and an external computing device. For example, the bore 104 extending through the body 102 may be any of a plurality of diameters corresponding to different ring sizes so that the device 100 may be worn on the finger of the user.

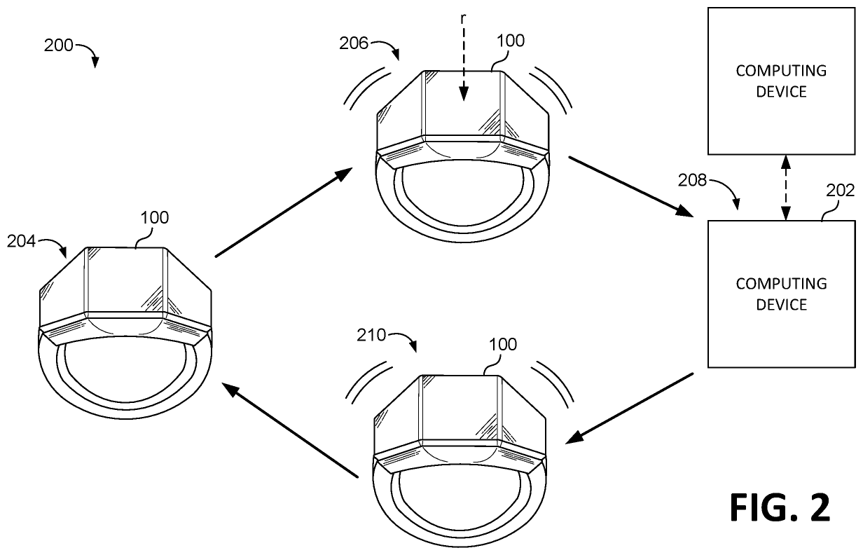

FIG. 2 illustrates a flow diagram of a system 200 including the device 100 of FIG. 1, according to some embodiments.

The system 200 includes the device 100 and a computing device 202 in electrically communicable connection with the device 100. The computing device 202 may include a processor and a memory. The memory may be a computer-readable medium having stored thereon instructions executable by the processor to perform operations to provide a seamless and reliable alert mechanism such as, for example, alerting emergency response services. The operations also include the computing device 202 generating a request and sending the request to a third-party computing device associated with the third-party computing device for dispatching resources to a location of the computing device 202 and the device 100.

In this regard, the computing device 202 may include one or more additional components to enable the computing device 202 to determine one or more characteristics associated with the computing device 202 and/or the device 100. The computing device 202 may include a communication module capable of wireless communication over Bluetooth and to send and receive BLE signal packets between the computing device 202 and the device 100. For example, the computing device 202 may include a global positioning sensor (“GPS”) to enable the computing device 202 to determine its location and to enable the computing device 202 to transmit its location or the location of the device 100 along with the request to the third-party computing device. In another example, the request sent by the computing device 202 may also include the altitude of the computing device 202 along with the GPS coordinates.

It can be appreciated that the computing device 202 can possess the hardware required to implement a variety of communication protocols (e.g., infrared (“IR”), shortwave transmission, near-field communication (“NFC”), Bluetooth, Wi-Fi, long-term evolution (“LTE”), 3G, 4G, 5G, 6G, global system for mobile communications (“GSM”), code-division multiple access (“CDMA”), satellite, visual cues, radio waves, etc.) The computing device 202 and/or various respective components can additionally comprise various graphical user interfaces (GUIs), input devices, or other suitable components.

Based on an input from the user at the device 100, the device 100 sends an electronic signal to the computing device 202 including one or more electronic signal packets indicative of the input and to, for example, initiate emergency alerts using the device 100. For example, the user may trigger the device 100 to switch from a first state to a second state and the device 100 sends an electrical signal to the computing device 202 indicative of the switching. The computing device 202 obtains the electronic signal from the device 100 and performs one or more operations based on the electrical signals. For example, the electrical signal sent by the device 100 may correspond to an emergency condition associated with the user and the computing device 202 generates and sends a request to another computing device requesting emergency resource services be dispatched to a location of the computing device 202. In some embodiments, the device 100 may be in wireless communicable connection with the computing device. In other embodiments, the device 100 may be in communicable connection with the computing device via Bluetooth or Bluetooth Low Energy (BLE).

The device 100 may be triggered by a user to switch the device 100 between the one or more states and to indicate an emergency condition associated with the user. In a non-limiting example, a user may trigger the device 100 based on the user or a third-party in proximity to the user experiencing a medical emergency and the user is requesting emergency response services be dispatched to a location of the user and/or the computing device 202. In another non-limiting example, a user may experience an injury which renders the user immobile and unable to reach computing device 202, e.g., the user's mobile phone. Accordingly, the user triggers the device 100 to wirelessly send an electrical signal over Bluetooth to the computing device 202 to indicate an emergency condition and to request emergency response services be dispatched from a third-party provider.

At 204, the device 100 may be in a first state indicative of a normal condition. At 206, in response to the user pressing on the top plate 122 and triggering the device 100 to switch from the first state to a second state, the device 100 may vibrate to provide haptic feedback to the user that the device 100 has switched from the first state to the second state. Furthermore, in some embodiments, the device 100 may one or more times provide other further indications such as, for example, to indicate the device 100 is in the second state, to confirm the request has been sent to the computing device 202, or some other indications.

At 208, the computing device 202 receives the electronic signals indicative of the device 100 switching from the first state to the second state. The computing device 202 obtains the electronic signals and generates and sends a request to another computing device associated with a third-party to dispatch resources to a location of the computing device 202 and/or the device 100. After the request is sent to the other computing device, or after the computing device 202 receives confirmation from the other computing device that resources have been dispatched, the computing device 202 may send an electronic signal to the device 100 indicative of the confirmation, according to some embodiments.

In some embodiments, the computing device 202 may send and receive electronic signals with the device 100 to perform a check-in operation. In some embodiments, after a first defined time period, the computing device 202 may send a signal to the device 100 to perform the check-in, and the device 100 may switch from the first state to a third state corresponding to the check-in operation.

At 210, the device 100 may, based on the electronic signals obtained from the computing device 202, cause the motor 126 to vibrate to physically signal the user of one or more conditions. Additionally, in some embodiments, the electronic signal obtained from the computing device 202 may also cause the device 100 to switch from one state to another state and cause the device 100 to vibrate to signal the user to provide an input at the device 100 to switch back to the first state, to switch to another different state, to send the computing device 202 confirmation of the switching by the computing device 202, other indications, or any combinations thereof.

In some embodiments, in response to receiving confirmation of the dispatch of resources from the computing device 202, the device 100 may vibrate to inform the user of the confirmation. Additionally, in some embodiments, in response to the computing device 202 causing the device 100 to switch to the third state, the device 100 may cycle the motor 126 to cause the device 100 to vibrate and to physically signal the user to provide input to the device 100 by pressing on the top plate 122 and triggering the device 100 to return the device 100 from the third state to the first state.

In response to the device 100 receiving (or not receiving) input from the user within a second defined time period, the device 100 may switch from one state to another state. For example, in some embodiments, in response to receiving the input and triggering the device 100, the device 100 switches from the third state back to the first state indicative of the user performing the check-in, as indicated from step 210 to step 204 in FIG. 2. Additionally, in some embodiments, the user may be required to press on the top plate 122 and activate the tactile switch 132 for a specific duration of time to switch the device 100 from one state to another state. For example, the user may have to trigger the tactile switch 132 for at least three seconds to switch the device 100 from the third state to the first state. Moreover, in response to the device 100 receiving the input that triggers the device 100 to switch states, the

Furthermore, in some embodiments, in response to the device 100 not receiving the input from the user within the second defined time period, the device 100 may switch from the third state to another state indicative of the user's failure to perform the check-in. In some embodiments, the device 100 may switch from the third state to the second state indicative of an emergency condition of the user based on the user failing to check in within the second time period.

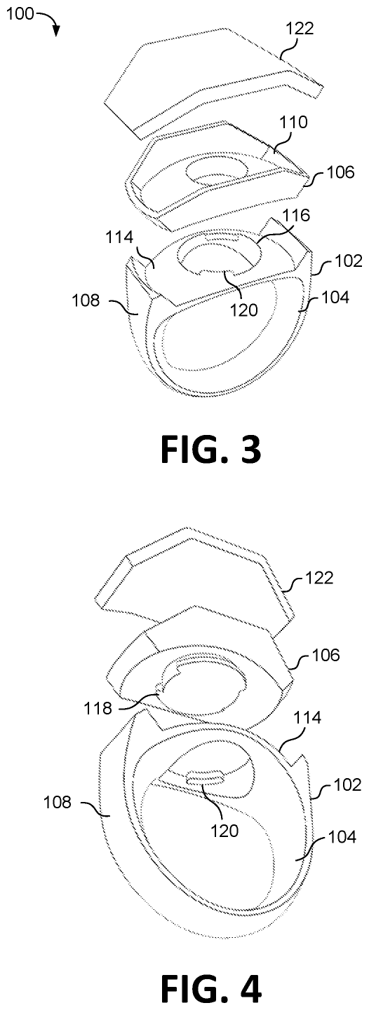

FIG. 3 illustrates a first partially exploded view of the device 100, according to some embodiments. FIG. 4 illustrates a second partially exploded view of the device 100, according to some embodiments. Unless specifically referenced, FIGS. 3 and 4 will be described collectively.

The device 100 includes a receptacle 106. The receptacle 106 may be disposed along an outer surface 108 of the body 102 and may include suitable dimensions based on the dimensions of the body 102 and for housing one or more components therein, such as the printed circuit assembly 124 (FIG. 2). For example, a bottom surface of the receptacle 106 may be rounded to correspond to the outer surface 108 of the body 102. The receptacle 106 includes an opening 110 defined by one or more sidewalls of the receptacle 106 for receiving the one or more components.

The receptacle 106 may be coupled to the body 102, according to some embodiments. The body 102 and the receptacle 106 may include one or more corresponding structural features for coupling the body 102 to the receptacle 106. In some embodiments, the body 102 may define a recess 114 along a portion of its outer surface 108 having dimensions which correspond to the outer dimensions of the receptacle 106 to allow the receptacle 106 to be coupled to the body 102 such that the sides of the body 102 and the receptacle 106 may be substantially planar. In some embodiments, the body 102 may include an aperture 116 that extends into the outer surface 108 of the body 102 (or through the body 102) at the recess 114 and the receptacle 106 may also include a protrusion 118 having dimensions corresponding to the dimensions of the aperture 116 and which is configured to be inserted into the aperture 116. Additionally, the aperture 116 may include one or more tabs 120 located along its inner surface for engaging one or more threads located on the protrusion 118, such that the receptacle 106 may be threadingly coupled to the body 102.

In some embodiments, the body 102 of the device 100 may be formed with the receptacle 106. The body 102 thereby defining the receptacle 106 and its opening. For example, the body 102 may be made of injection molded thermoplastics which forms the annular portion of the body 102 and the receptacle 106.

According to some embodiments, body 102 and receptable 106 may be solid bodies (e.g., solid surfaces) that include male and female structures that enable their secure connection (e.g., clips, mates, tabs, and the like, including known or to be known forms of adhesion to join to separate bodies). Thus, in some embodiments, body 102 may be solid (e.g., no aperture 116) and receptacle 106 may not include the protrusion 118 for insertion to aperture 116.

The device 100 includes a top plate 122. The top plate 122 may be arranged on the device 100 adjacent the receptacle 106. In some embodiments, the top plate 122 may be coupled to the body 102 at the receptacle 106 such that the top plate 122 may slidably move in a radial direction relative to a central axis of the body 102 in response to a force being applied to the top plate by the user, as will be further described herein. In other embodiments, the top plate 122 may be movably coupled to the body 102 such that the top plate 122 may move in a downward direction in response to a force being applied to a top surface of the top plate 122 and may move in an upward direction in response to a spring force acting on a bottom surface of the top plate 122 in response to the force applied to the top surface being removed.

The top plate 122 may include appropriate dimensions which enable the top plate 122 to be positioned at the receptacle 106 while allowing the top plate 122 to move in the radial direction relative to the central axis of the device 100 in response to one or more forces being applied to the top plate 122. The dimensions of the top plate 122 may be based on the dimensions of the receptacle 106, according to some embodiments. In some embodiments, the top plate 122 may include appropriate dimensions based on the receptacle 106 dimensions such that the top plate 122 covers or substantially covers the opening 110 of the receptacle 106. In other embodiments, the top plate 122, or a portion thereof, may include dimensions greater than the dimensions of the opening 110 of the receptacle 106.

The top plate 122 may include appropriate dimensions based on the dimensions of the receptacle 106 which enable the top plate 122, or a portion thereof, to be positioned within the sidewalls of the receptacle 106, in some embodiments. For example, the top plate 122 may include one or more protrusions which are configured to extend into the receptacle 106 to help retain the top plate 122 in alignment with the receptacle 106. Additionally, the top plate 122 may be arranged such that the top plate 122, or a portion thereof, protrudes from the opening 110 of the receptacle 106, and which enable the user to more easily press on the top plate 122 to trigger the switching of the device 100 between the one or more states. In other embodiments, the top plate 122 may be positioned in the receptacle 106 so that the top plate 122 does not protrude from a top surface of the receptacle 106 so as to reduce the likelihood that the user will unintentionally trigger the device 100 to switch between the one or more states.

In response to being triggered by the user, the device 100 transitions or switches between the one or more states such as, for example, from a first state to a second state. Furthermore, in response to the switching of states by the device 100, the device 100 sends and receives electronic signal between the device 100 and the computing device 202 in response to the switching and request for dispatch of emergency response services.

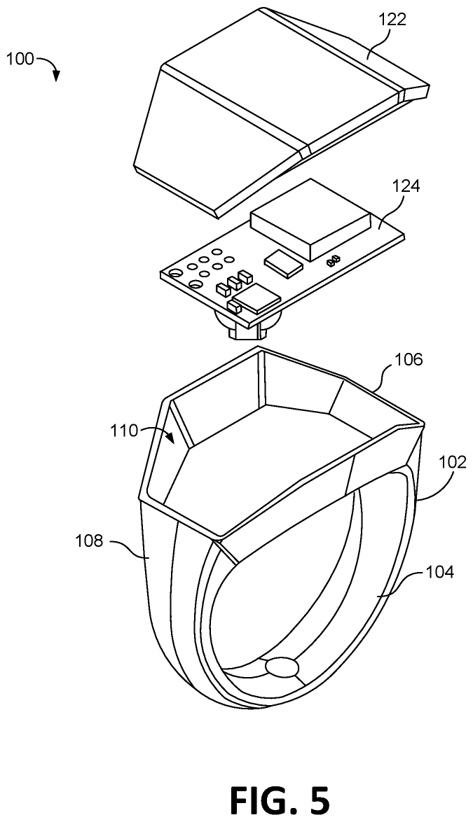

FIG. 5 illustrates a top view of a printed circuit assembly 124, according to some embodiments.

The device 100 includes a printed circuit assembly 124. The printed circuit assembly 124 may be installed into the device 100 at the receptacle 106 and the top plate 122 may be arranged over the printed circuit assembly 124 in the receptacle 106. Furthermore, the top plate 122 may include structural features which enable the top plate 122 to trigger a tactile switch 132 arranged on the printed circuit assembly 124, as will be further described herein. For example, in some embodiments, the top plate 122 may include an embossment arranged on its bottom surface, which may be in collinear alignment with the tactile switch to enable the triggering. In another example, the contact on the tactile switch 132 may include appropriate dimensions to extend from a surface of the printed circuit assembly 124 and to contact a bottom of the top plate 122, such that pressing down on the top plate 122 triggers the tactile switch 132.

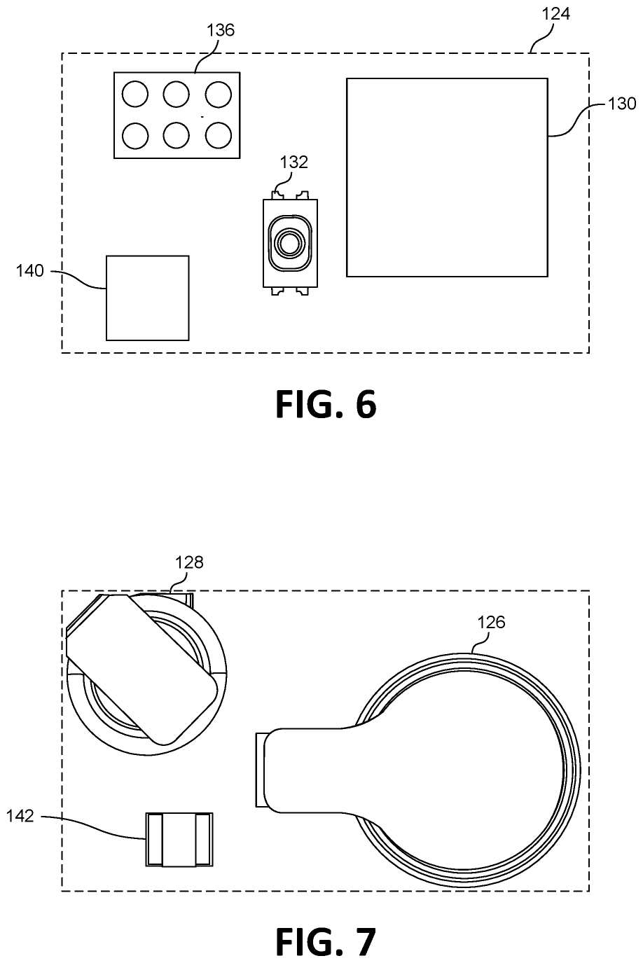

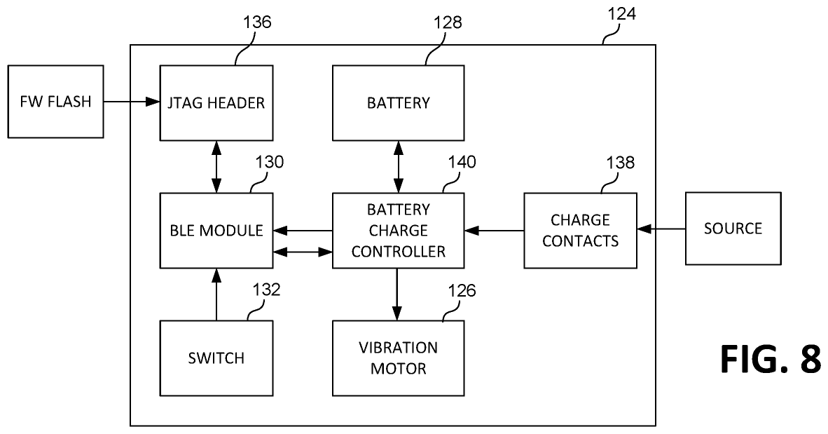

FIG. 6 illustrates a schematic diagram of a top view of the printed circuit assembly 124, according to some embodiments. FIG. 7 illustrates a schematic diagram of a bottom view of the printed circuit assembly 124, according to some embodiments. FIG. 8 illustrates a block diagram of the printed circuit assembly 124, according to some embodiments. Unless specifically referenced, FIGS. 6-8 will be described collectively.

The printed circuit assembly 124 includes a vibration device (motor or buzzer) 126, a battery 128, a communication module 130, and a tactile switch 132. In some embodiments, the printed circuit assembly 124 may include a controller 130 for controlling the operations of the printed circuit assembly 124. Additionally, the printed circuit assembly 124 may include a processor and a non-transitory computer readable medium (i.e., memory) having stored thereon instructions executable by the processor to perform operations in accordance with the present disclosure. In some embodiments, the controller 130 may include therein the processor and memory.

The printed circuit assembly 124 includes the motor 126. In some embodiments, the motor 126 may be a vibration motor or piezo buzzer which may be cycled on and off to cause the device 100 to vibrate in response to one or more conditions. In some embodiments, the motor 126 may be cycled to cause the device 100 to vibrate to provide haptic feedback to the user. For example, the device 100 may vibrate in response to the user pressing the top plate 122 and triggering the device 100 to switch between the one or more states. In another example, the device 100 may vibrate in response to being connected to the computing device 202. In one example, the device 100 may vibrate in response to detecting being placed in electrical connection with a power source for charging the printed circuit assembly 124. In yet another example, the device 100 may vibrate in response to one or more electrical signal packets received from the computing device 202.

In this regard, the motor 126 may be cycled according to different predefined sequences to provide different indications to the user based on the sequence. For example, the device 100 may vibrate in a series of rapid bursts which repeat over a certain number of intervals to indicate to the user wearing the device 100 to perform a regularly scheduled check-in by pressing on the top plate 122 and triggering the tactile switch 132.

The printed circuit assembly 124 includes the battery 128. The battery 128 provides power to the printed circuit assembly 124 in the form of DC current, and which enables the printed circuit assembly 124 to perform the operations in accordance with the present disclosure. In some embodiments, the battery 128 may be a rechargeable battery.

The printed circuit assembly 124 includes a communication module 130. The communication module 130 enables the device 100 to be placed in communicable connection with the computing device 202. The communication module 130 may include one or more components that enable the communication module 130 to be placed in wirelessly communicable connection with the computing device 202. For example, the communication module 130 may include an antenna and receiver for sending and receiving electronic signal packets between the printed circuit assembly 124 and the computing device 202 over a wireless communication protocol. Referring to FIG. 8, the communication module 130 may be a Bluetooth Light Enabled System-on-Chip capable of Bluetooth enabled wireless communication for sending and receiving BLE signal packets between the device 100 and another computing device, such as computing device 202.

It can be appreciated that the communication module 130 can possess the hardware required to implement a variety of communication protocols (e.g., infrared (“IR”), shortwave transmission, near-field communication (“NFC”), Bluetooth, Wi-Fi, long-term evolution (“LTE”), 3G, 4G, 5G, 6G, global system for mobile communications (“GSM”), code-division multiple access (“CDMA”), satellite, visual cues, radio waves, etc.) The device 100 and/or various respective components can additionally comprise various graphical user interfaces (GUIs), input devices, or other suitable components.

Additionally, the printed circuit assembly 124 may include a connection interface 136 for physically connecting the printed circuit assembly 124 to another device using an electrical cable, according to some embodiments. In some embodiments, the connection interface 136 may be a JTAG connector for connecting a computing device, such as computing device 202, to the printed circuit assembly 124. For example, the computing device may connect to the printed circuit assembly 124 using the connection interface 136 to update the firmware stored on the printed circuit assembly 124.

The printed circuit assembly 124 includes a tactile switch 132. The tactile switch 132 may be in contact with a bottom surface of the top plate 122, where a force being applied to a top surface of the top plate 122 causes the top plate 122 to move downward towards the central axis of the device 100, thereby triggering the tactile switch 132. Furthermore, although not shown in the figures, the tactile switch 132 may include a tensioning element which provides a spring force onto a bottom of the top plate 122. Accordingly, to trigger the tactile switch 132, the force applied to the top surface of the top plate 122 by the user must overcome the spring force of the tensioning element. Additionally, in response to the force applied to the top surface of the top plate 122 being removed, the tensioning element returns the top plate 122 and the tactile switch 132 to their original positions.

The printed circuit assembly 124 includes a controller 130. The controller 130 may control one or more operations of the printed circuit assembly 124 for sending and receiving electronic signals between the device 100 and the computing device 202 in response to a user input and indicative of the device 100 switching between the one or more states. In some embodiments, the controller 130 may control operation of the printed circuit assembly 124 based on a power level of the battery 128. In this regard, in some embodiments, the printed circuit assembly 124 may also include a battery management component 140 which provides the controller 130 with information corresponding to a condition of the battery 128 to enable efficient processing of operations by the controller 130. For example, the controller 130 may place the printed circuit assembly 124 in active connection with the computing device 202 when the power level of the battery 128 is greater than a first threshold and the printed circuit assembly 124 may switch to a passive connection with the computing device 202 when the power level of the battery 128 is less than the first threshold or less than a second threshold. In another example, when the power level of the battery 128 is below a certain threshold, the controller 130 may cycle the motor 126, causing the device 100 to vibrate and to indicate to the user that the device 100 needs charging. In this regard, the controller 130 may control the one or more operations of the device 100 in accordance with the present disclosure based on the power level of the battery 128.

Referring to FIG. 8, the printed circuit assembly 124 may also include charge contacts 138 for placing the printed circuit assembly 124 in electrical connection with a power source to power the printed circuit assembly 124 and/or to charge the battery 128. In some embodiments, the printed circuit assembly 124 may be placed in connection with the power source using an electrical cable to supply power to the printed circuit assembly 124. In some embodiments, the charge contacts 138 may be a connector for physically connecting the electrical cable to the printed circuit assembly 124. In other embodiments, the charge contacts 138 may be inductive charge contacts for inductively charging the printed circuit assembly 124 with the power source.

It is to be appreciated by those having ordinary skill in the art that components of the device 100 and the printed circuit assembly 124 are not intended to be limiting and that, although not explicitly described herein, they may include other components which enable the device 100 to perform the operations in accordance with the present disclosure. For example, the printed circuit assembly 124 may include therein a power inductor 142 (as depicted in FIG. 7) to receive power from a power source, such as from a 110 V electrical outlet placed in electrical connection with the printed circuit assembly 124 at the charge contacts 138.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

As used herein “embedded” means that a first material is distributed throughout a second material.

What is claimed is:

1. A safety system comprising:
a smart ring device,
wherein the smart ring device is capable of wireless communication,
wherein the smart ring device is configured to transition between one or more states based on inputs from a user; and
a first computing device comprising:
a computer-readable medium having stored thereon instructions for sending a request to a second computing device associated with a third-party emergency response service for dispatching resources to a location of the first computing device;
wherein, in response to switching from a first state to a second state, the smart ring device sends an electrical signal to the first computing device indicative of an emergency condition associated with the user and for the first computing device to send the request to the second computing device.

2. The safety system of claim 1, wherein the smart ring device is configured to provide haptic feedback through vibrations in response to the inputs from the user and in response to the smart ring device transitioning to each of the one or more states.

3. The safety system of claim 1, wherein the smart ring device comprises:
a ring-shaped body comprising:
a receptacle disposed along a portion of an outer surface of the ring-shaped body;
a top plate movably coupled to the ring-shaped body at the receptacle; and
a printed circuit assembly comprising:
a vibration component,
a battery,
a communication module, and
a tactile switch,
wherein the printed circuit assembly is disposed in the receptacle between the ring-shaped body and the top plate;
wherein, in response to a force being applied to the top plate and triggering the tactile switch, the printed circuit assembly transitions the smart ring device between one of the one or more states to another one of the one or more states.

4. The safety system of claim 3, wherein the printed circuit assembly further comprises:
a controller,
wherein the controller is configured to control an operation of one or more components of the printed circuit assembly to extend a life of the battery.

5. The safety system of claim 3, where the communication module comprises:
a Bluetooth Low Energy (BLE) System-on-Chip (SoC),
wherein the communication module is capable of Bluetooth enabled communication with the first computing device.

6. The safety system of claim 3, wherein, after a first defined time period, the smart ring device switches from the first state to a third state and cycles the vibration component to physically signal the user to provide the input to the smart ring device to return the smart ring device to the first state.

7. The safety system of claim 6, wherein, in response to the smart ring device receiving the input from the user for a specific duration of time within a second defined time period, the smart ring device switches from the third state to the first state,
wherein, in response to the smart ring device not receiving the input from the user within the second defined time period, the smart ring device switches to the second state.

8. A smart ring apparatus comprising:
a body comprising:
a receptacle disposed along a portion of an outer surface of the body;
a top plate,
wherein the top plate is configured to movably couple to the body; and
a printed circuit assembly comprising:
a vibration component,
a battery,
a communication module capable of Bluetooth wireless communication with a first computing device, and
a tactile switch,
wherein the printed circuit assembly is disposed at the receptacle between the body and the top plate;
wherein the printed circuit assembly switches between one or more states based on an input from a user applied to the top plate triggering the tactile switch.

9. The smart ring apparatus of claim 8, wherein the printed circuit assembly cycles the vibration component to provide haptic feedback to the user in response to the inputs from the user and in response to the printed circuit assembly switching between each of the one or more states.

10. The smart ring apparatus of claim 8, wherein, in response to triggering the tactile switch, the printed circuit assembly switches from a first state to a second state and sends an electrical signal to the first computing device, the second state being indicative of an emergency condition associated with the user,
wherein, in response to the electrical signal indicative of being in the second state, the first computing device sends a request to a second computing device associated with a third-party emergency response service for dispatching resources to a location of the first computing device.

11. The smart ring apparatus of claim 10, wherein, after a first defined time period, the printed circuit assembly switches to a third state and cycles the vibration component to physically signal to the user to press the top plate and trigger the tactile switch to return the printed circuit assembly to the first state.

12. The smart ring apparatus of claim 11, wherein, in response to the tactile switch being triggered for a specific duration within a second defined time period, the printed circuit assembly switches from the third state to the first state.

13. The smart ring apparatus of claim 11, wherein, in response to the tactile switch not being triggered within a second defined time period, the printed circuit assembly switches to the second state.

14. The smart ring apparatus of claim 8, wherein the printed circuit assembly comprises:
a controller,
wherein the controller is configured to control operations of the printed circuit assembly to extend a life of the battery.

15. The smart ring apparatus of claim 8, where the communication module comprises:
a Bluetooth Low Energy (BLE) System-on-Chip (SoC).

16. A method for initiating emergency alerts using a smart ring device and a first computing device comprising:
activating, by the smart ring device, an emergency alert system in response to an input from a user triggering the smart ring device to switch from a first state to a second state;
sending, by the smart ring device and based on the input from the user triggering the second state, an electronic signal to a first computing device corresponding to a request for emergency response services to be dispatched to a location of the first computing device;
obtaining, by the first computing device, a confirmation from a second computing device indicative of resources being dispatched to the location of the first computing device; and
triggering, by the smart ring device, haptic feedback by cycling a vibration component to physically signal to the user the confirmation.

17. The method of claim 16, further comprising:
receiving, at the smart ring device, an input from the user at a top plate of the smart ring device and triggering a trigger switch to cause the smart ring device to switch from the first state to the second state; and
sending and receiving Bluetooth Low Energy (BLE) packets between the smart ring device and the first computing device, the BLE packets including the request for the emergency response services.

18. The method of claim 16, further comprising:
switching, by the smart ring device after a first defined time period, from the first state to a third state and cycling the vibration component to physically signal to the user to provide the input to the smart ring device to return the smart ring device to the first state.

19. The method of claim 18,
switching, in response to the smart ring device receiving the input from the user for a specific duration of time within a second defined time period, the smart ring device from the third state to the first state.

20. The method of claim 19,
switching, in response to the smart ring device not receiving the input from the user within the second defined time period, the smart ring device from the third state to the second state; and
sending, by the smart ring device in response to switching from the third state to the second state, the electronic signal to the first computing device corresponding to a request for emergency response services to be dispatched to the location of the first computing device.
